(19) United States
(12) Patent Application Publication
(10) Pub. No.: US 2008/0235370 A1
(43) Pub. Date: Sep. 25, 2008

(54) Method and System for Controlling Network Traffic of P2P and Instant Messenger Softwares

(75) Inventors: Ilhoon Choi, Seoul (KR); Tae Wan Kim, Seoul (KR); Dae Hwan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Somansa Co., Ltd., Seoul (KR)

(21) Appl. No.: 11/944,750

(22) Filed: Nov. 26, 2007

(30) Foreign Application Priority Data
Mar. 21, 2007 (KR) 10-2007-0027696

(51) Int. Cl. G06F 15/173

(52) U.S. Cl. 709/224

(57) ABSTRACT

A method and a system for controlling a network traffic of P2P and instant messenger softwares are disclosed. In accordance with the method and the system, both a header and a payload of a packet generated by an instant messenger software or a P2P software are monitored to terminate a session by transmitting a termination signal to a receiver and a transmitter when required, thereby blocking the exchange of the attached file and storing the content of the conversation.

### BACKGROUND OF THE INVENTION

1. Field of the Invention

The present invention relates to a method and a system for controlling a network traffic of P2P and instant messenger softwares, and in particular to a method and a system for controlling a network traffic of P2P and instant messenger softwares wherein both a header and a payload of a packet generated by an instant messenger software or a P2P software are monitored to terminate a session by transmitting a termination signal to a receiver and a transmitter when required, thereby blocking the exchange of the attached file and storing the content of the conversation.

2. Description of the Related Art

Recently, a use of an instant messenger software allowing a conversation between individuals or a P2P (Peer-to-Peer) software allowing a file exchange between the individuals is increasing rapidly. Because the instant messenger software or the P2P software obstructs working when used during a working hour, most of companies blocks the use thereof or allows the use thereof limitedly.

Particularly, the instant messenger software or the P2P software allows a transmission of a large attached file having a size up to few hundred megabytes, there is a possibility that an information of a large scale may be leaked out.

As can be known from Sabanes-Oxley Act, a regulation of American Stock Exchange and a recommendation of Korean Financial Supervisory Service, a financial institution requires storing a content of a conversation via an instant messenger between an investment advisor and a client for a predetermined period.

Therefore, a demand for a function of accurately storing the content of the conversation and attached file of the instant messenger software and the P2P software is increasing.

In order to block a use of the softwares, a firewall is used to block a communication via a specific port or to a specific IP address.

The firewall is a security system acting as a protective boundary between a network and an outside world. An internet connection firewall is a device used for configuring a restrictive condition of information communicated between the network or a small network and the Internet. The firewall refers to a general firewall focused on a packet filtering for monitoring a communication through a corresponding path, inspecting a network address (such an IP address) and the port of a processed packet, and enforcing a control policy based on the network address and the port. In addition, the firewall allows an outbound traffic and blocks an inbound traffic such that the network is invisible from the outside world.

Recently, in order to block a hacking and an intrusion, an IPS (Intrusion Prevention System) is employed. A main function of the IPS is to block the intrusion. The IPS additionally has a function of controlling a transfer of an attached file of the instant messenger, popular instant messenger such as MSN messenger in particular.

However, due to a limitation of a performance of the IPS, the IPS cannot monitor a packet flow information of the instant messenger such as the MSN messenger constantly. The IPS is capable of only controlling a session when a specific packet template, i.e. a packet compliant to an attached file transfer packet template is detected.

In addition, the IPS does not include functions of controlling a detailed condition such as a user, a time and a content of the attached file and storing a content of a conversation and the attached file.

When an equipment for blocking a connection such as the firewall is used, the connection to a specific port or a specific IP address may be blocked. However, most of the instant messenger softwares provide an option for bypassing the blocking.

FIG. 1 is a block diagram illustrating a conventional network configuration.

Referring to FIG. 1, a first user terminal 40 connects to the Internet via a firewall 20 and a router 30.

When a connection is to be blocked in a network shown in FIG. 1, the connection is blocked through a specific port or according to an IP address.

For instance, the MSN messenger connects to a messenger server using ports 1863 and 6891 through 6900. When the firewall blocks the ports 1863 and 6891 through 6900, the MSN messenger may connect to the messenger server by using a port 80 or a proxy server. Since the port 80 is an http (HyperText Transfer Protocol) port, an entirety of a web connection is blocked when the port 80 is blocked. Therefore, the blocking of the port 90 is not possible.

In particular, a file transfer as well as a conversation is possible using the instant messenger software, it is impossible to block a confidential file from being leaked to outside.

### SUMMARY OF THE INVENTION

It is an object of the present invention to provide a method and a system for controlling a network traffic of P2P and instant messenger softwares wherein both a header and a payload of a packet generated by an instant messenger software or a P2P software are monitored to terminate a session by transmitting a termination signal to a receiver and a transmitter when required, thereby blocking the exchange of the attached file and storing the content of the conversation.

In order to achieve above-described object of the present invention, there is provided a method for controlling a traffic generated by at least one of a P2P software and an instant messenger software, the method comprising steps of: (a) logging in through one of the P2P software and the instant messenger software at a first user terminal as a first user; (b) carrying out a communication between the first user and a second user including at least one of a conversation and a file transfer; (c) monitoring a traffic of the communication; and (d) analyzing a header and a payload of a packet included in the traffic based on a network policy assigned to the analysis to notify a blocking of the communication or a generation of a packet to be blocked to the first user.

It is preferable that the step (d) comprises transmitting at least one of a session termination signal and a reset signal to the first user terminal and a second user terminal receiving the traffic to terminate a session when the traffic is monitored using a mirroring method in the step (c).

It is preferable that the step (d) comprises blocking the communication by dropping the packet included in the traffic when the traffic is monitored using an in-line method in the step (c).

It is preferable that the network policy comprises at least one of a network connection time, a network connection software, a connection port, a connected IP address, a user group, a text data included in the packet in the traffic, a file name of a transferred file, a keyword included in the file and a size of the file.

The method in accordance with the present invention may further comprise storing a text data included in the packet and a transferred file.

It is preferable that the step of storing comprises storing a data included in the packet as a large capacity relational database after carrying out a morpheme analysis and an indexing of the data.

It is preferable that the step (c) comprises: mirroring an outbound traffic transmitted from the first user terminal and an inbound traffic transmitted from a second user terminal receiving the network traffic; and monitoring the outbound traffic and the inbound traffic.

It is preferable that the step (d) comprises analyzing a signature included in the payload.

It is preferable that the step (d) comprises analyzing the payload to determine whether the payload includes a personal identification information including a credit card number, an account number and a cellular phone number, a personal information and a confidential company information.

The method in accordance with the present invention may further comprise further comprising notifying the blocking of the communication to an administrator in a real time.

It is preferable that the blocking of the communication is notified to the administrator via at least one of an email, an SMS and the instant messenger software.

The method in accordance with the present invention may further comprise further comprising decoding a data included in the packet when the data is encoded by at least one of a multi-language analysis, a two byte character processing, a MIME and an UTF.

There is also provided network traffic control system for controlling a traffic generated by at least one of a P2P software and an instant messenger software, the system comprising a control module for monitoring a communication through one of a P2P software and an instant messenger software and analyzing a header and a payload of a packet included in the traffic based on a network policy assigned to the analysis to notify a blocking of the communication or a generation of a packet to be blocked to a first user.

It is preferable that the control module transmits at least one of a session termination signal and a reset signal to a first user terminal and a second user terminal receiving the traffic to terminate a session when the traffic is monitored using a mirroring method.

It is preferable that the control module blocks the communication by dropping the packet included in the traffic when the traffic is monitored using an in-line method.

It is preferable that the network policy comprises at least one of a network connection time, a network connection software, a connection port, a connected IP address, a user group, a text data included in the packet in the traffic, a file name of a transferred file, a keyword included in the file and a size of the file.

The system in accordance with the present invention may further comprise further comprising a storage module for storing a text data included in the packet and a transferred file.

It is preferable that the storage module comprises a large capacity relational database.

### BRIEF DESCRIPTION OF THE DRAWINGS

FIG. 1 is a block diagram illustrating a conventional network configuration.

FIG. 2 is a block diagram illustrating a first embodiment of a network traffic control system for controlling a traffic of a P2P software and an instant messenger software in accordance with the present invention.

FIG. 3 is a block diagram illustrating a second embodiment of a network traffic control system for controlling a traffic of a P2P software and an instant messenger software in accordance with the present invention.

FIG. 4 is a flow diagram illustrating a method for controlling a network traffic a traffic of a P2P software and an instant messenger software in accordance with the present invention.

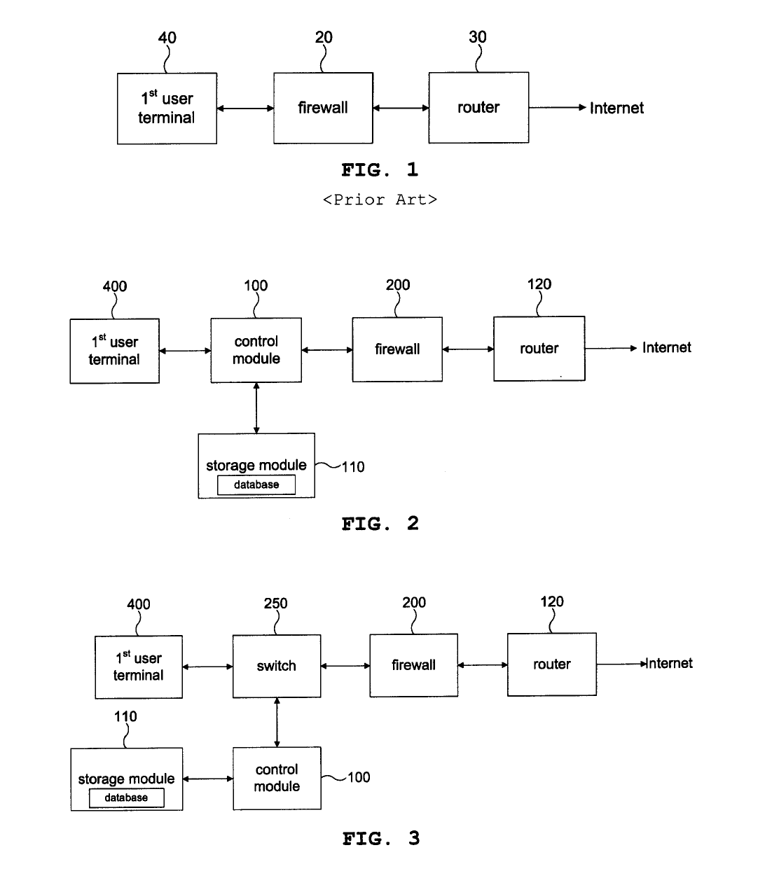

### DETAILED DESCRIPTION OF THE INVENTION

The present invention will now be described in detail with reference to the accompanied drawings. The interpretations of the terms and wordings used in Description and Claims should not be limited to common or literal meanings. The embodiments of the present invention are provided to describe the present invention more thoroughly for those skilled in the art.

FIG. 2 is a block diagram illustrating a first embodiment of a network traffic control system for controlling a traffic of a P2P software and an instant messenger software in accordance with the present invention, wherein a network traffic is monitored via an in-line method.

Referring to FIG. 2, the network traffic control system for controlling the traffic of the P2P software and the instant messenger software in accordance with the present invention comprises a control module 100. The network traffic control system for controlling the traffic of the P2P software and the instant messenger software in accordance with the present invention may further comprise a storage module 110.

The network traffic control system for controlling the traffic of the P2P software and the instant messenger software in accordance with the present invention monitors a traffic of the traffic of a session opened according to a network connection request and analyzes a header and a payload of a packet included in the traffic based on a network policy assigned to the analysis to block a connection.

The P2P software or the instant messenger software installed in a first user terminal 400 attempts to establish a communication through a firewall 200 and a router 300.

When the connection is established for the P2P software or the instant messenger software, the control module 100 monitors a packet of the network traffic generated between users.

The control module 100 constantly monitors a header and a payload of the packet. When at least one of the header and the payload of the packet violates a network policy, the communication is dropped by dropping the packet. For instance, when the user uses the instant messenger software to carry out a conversation, the connection is immediately blocked in case a content of the conversation, i.e. a text data included in the packet includes a word to be blocked.

In addition, when the user attempts to transfer a file using the instant messenger software, the control module 100 immediately blocks the connection in case a filename of the file corresponds to that of a file forbidden to be transmitted.

When the user requests a file transfer, the instant messenger software transmits an information packet including the filename and a size of the file prior to the file transfer. The control module 100 blocks the connection when the filename or the size of the file included in the information packet corresponds to the forbidden filename or the size, that is, the file has a forbidden extension or the size thereof is larger than a predetermined size. Specifically, when the packet includes the filename having the forbidden extension, the control module 100 drops the packet including the filename and the size of the file, that is, the control module 100 does not transmit the packet to a second user using a second user terminal by dropping the packet.

The network policy comprises at least one of a network connection time, a network connection software, a connection port, a connected IP address, a user group, the text data included in the packet in the traffic, a file name of a transferred file, a keyword included in the file and a size of the file.

Specifically, the connection may be blocked according to a user ID. Whether to block the connection may be determined according to a time of the connection, that is, whether the connection is established during a working hour. Moreover, the connection may be blocked when the user establishes a connection using a forbidden software, and a corresponding connection port may be blocked when a specific connection port is used.

In addition, when an IP address of the first user terminal or the second user terminal is a forbidden IP address, the control module 100 may block the connection. The control module 100 may allow the connection according to a user group. That is, a user in a marketing team may be allowed to use the instant messenger software for the connection and the user in a finance team may be prohibited from using the instant messenger software for the connection.

Moreover, the payload of the packet may be analyzed to determine whether the payload includes a personal identification information including a credit card number, an account number and a cellular phone number, a personal information and a confidential company information, thereby blocking the connection according to a configuration.

The control module 100 may notify the generation of the packet to be blocked to the user as well as blocking the connection.

For instance, when the packet to be blocked is generated, the packet to be blocked is blocked and the blocking of the packet is notified to the first user or the generation of the packet to be blocked may be notified to the first user prior to the blocking thereof.

Moreover, the control module 100 may notify the blocking of the packet to an administrator via at least one of an email, an SMS (short Message Service) and the instant messenger.

The network traffic control system for controlling the traffic of the P2P software and the instant messenger software in accordance with the present invention may further comprise the storage module 110. The storage module 110 stores the text data included in the packet and the transferred file.

The storage module 110 may comprise a large capacity relational database. Particularly, it is preferable that the attached file and the content of the conversation are stored as the large capacity relational database after carrying out a morpheme analysis and an indexing of the data included in the packet.

FIG. 3 is a block diagram illustrating a second embodiment of a network traffic control system for controlling a traffic of a P2P software and an instant messenger software in accordance with the present invention, wherein a network traffic is monitored via an mirroring method.

Referring to FIG. 3, the network traffic control system for controlling the traffic of the P2P software and the instant messenger software in accordance with the present invention comprises a control module 100. The network traffic control system for controlling the traffic of the P2P software and the instant messenger software in accordance with the present invention may further comprise a storage module 110.

The network traffic control system for controlling the traffic of the P2P software and the instant messenger software in accordance with the present invention monitors a traffic of the traffic of a session opened according to a network connection request and analyzes a header and a payload of a packet included in the traffic based on a network policy assigned to the analysis to block a connection.

The P2P software or the instant messenger software installed in a first user terminal 400 attempts to establish a communication through a firewall 200 and a router 300.

When the connection is established for the P2P software or the instant messenger software, the control module 100 receives the traffic through a mirroring port of a switch 250 and constantly monitors a header and a payload of the packet. When at least one of the header and the payload of the packet violates a network policy, the communication is blocked.

For instance, when the user uses the instant messenger software to carry out a conversation, the connection is immediately blocked in case a content of the conversation, i.e. a text data included in the packet includes a word to be blocked.

In addition, when the user attempts to transfer a file using the instant messenger software, the control module 100 immediately blocks the connection in case a filename of the file corresponds to that of a file forbidden to be transmitted.

When the user requests a file transfer, the instant messenger software transmits an information packet including the filename and a size of the file prior to the file transfer. The control module 100 blocks the connection when the filename or the size of the file included in the information packet corresponds to the forbidden filename or the size, that is, the file has a forbidden extension or the size thereof is larger than a predetermined size. For instance, when the packet includes the filename having the forbidden extension or is larger than a predetermined size, the control module 100 transmits at least one of a session termination signal and a reset signal to the first user terminal and a second user terminal receiving the traffic to terminate the session.

The network policy comprises at least one of a network connection time, a network connection software, a connection port, a connected IP address, a user group, the text data included in the packet in the traffic, a file name of a transferred file, a keyword included in the file and a size of the file.

Specifically, the connection may be blocked according to a user ID. Whether to block the connection may be determined according to a time of the connection, that is, whether the connection is established during a working hour. Moreover, the connection may be blocked when the user establishes a connection using a forbidden software, and a corresponding connection port may be blocked when a specific connection port is used.

In addition, when an IP address of the first user terminal or the second user terminal is a forbidden IP address, the control module 100 may block the connection. The control module 100 may allow the connection according to a user group. That is, a user in a marketing team may be allowed to use the instant messenger software for the connection and the user in a finance team may be prohibited from using the instant messenger software for the connection.

Moreover, the payload of the packet may be analyzed to determine whether the payload includes a personal identification information including a credit card number, an account number and a cellular phone number, a personal information and a confidential company information, thereby blocking the connection according to a configuration.

The control module 100 may notify the generation of the packet to be blocked to the user as well as blocking the connection.

For instance, when the packet to be blocked is generated, the packet to be blocked is blocked and the blocking of the packet is notified to the first user or the generation of the packet to be blocked may be notified to the first user prior to the blocking thereof.

Moreover, the control module 100 may notify the blocking of the packet to an administrator via at least one of an email, an SMS (short Message Service) and the instant messenger.

The network traffic control system for controlling the traffic of the P2P software and the instant messenger software in accordance with the present invention may further comprise the storage module 110. The storage module 110 stores the text data included in the packet and the transferred file.

The storage module 110 may comprise a large capacity relational database. Particularly, it is preferable that the attached file and the content of the conversation are stored as the large capacity relational database after carrying out a morpheme analysis and an indexing of the data included in the packet.

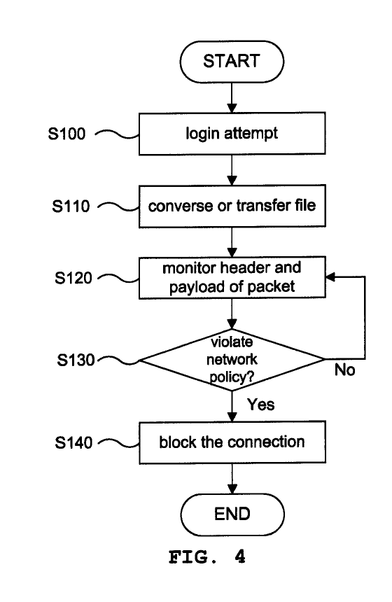

FIG. 4 is a flow diagram illustrating a method for controlling a network traffic a traffic of a P2P software and an instant messenger software in accordance with the present invention.

Referring to FIG. 4, a first user attempts to log in through one of a P2P software and an instant messenger software running at a first user terminal (S100).

When the login process is complete, the P2P software or the instant messenger software carries out a communication, i.e. at least one of a conversation and a file transfer between the first user and a second user (S110).

Thereafter, the network traffic such as the conversation and the file transfer is monitored (S120). A payload as well as a header of the packet is monitored during the monitoring process.

The monitoring process may be carried out via an in-line method or a mirroring method. For instance, the packet obtained by mirroring an outbound traffic transmitted from the first user terminal and an inbound traffic transmitted from the second user terminal may be monitored.

When only the header of the packet is monitored, a bypass connection of the instant messenger software through a port number 80 cannot be blocked. However, when the payload as well as the header is monitored, the bypass connection of the instant messenger software may be blocked because the entire content of the packet may be known.

The network policy comprises at least one of a network connection time, a network connection software, a connection port, a connected IP address, a user group, the text data included in the packet in the traffic, a file name of a transferred file, a keyword included in the file and a size of the file.

Thereafter, the header and the payload of the packet included in the traffic are analyzed (S130) and the connection is blocked when the network policy assigned to the packet is violated (S140).

For instance, when the packet to be blocked is generated, the packet to be blocked is blocked and the blocking of the packet is notified to the first user or the generation of the packet to be blocked may be notified to the first user prior to the blocking thereof.

Moreover, the blocking of the packet may be notified to an administrator via at least one of an email, an SMS and the instant messenger.

When the packet does not violate the network policy, the monitoring process is repeatedly carried out (S120).

As described above, in accordance with the method for controlling the network traffic and the network traffic control system, both of the header and the payload of the packet generated by the instant messenger software or the P2P software are monitored to terminate the session by transmitting the termination signal to the first user terminal and the second user terminal when necessary, thereby blocking the exchange of the attached file and storing the content of the conversation.

What is claimed is:

1. A method for controlling a traffic generated by at least one of a P2P software and an instant messenger software, the method comprising steps of:
(a) logging in through one of the P2P software and the instant messenger software at a first user terminal as a first user;
(b) carrying out a communication between the first user and a second user including at least one of a conversation and a file transfer;
(c) monitoring a traffic of the communication; and
(d) analyzing a header and a payload of a packet included in the traffic based on a network policy assigned to the analysis to notify a blocking of the communication or a generation of a packet to be blocked to the first user.

2. The method in accordance with claim 1, wherein the step (d) comprises transmitting at least one of a session termination signal and a reset signal to the first user terminal and a second user terminal receiving the traffic to terminate a session when the traffic is monitored using a mirroring method in the step (c).

3. The method in accordance with claim 1, wherein the step (d) comprises blocking the communication by dropping the packet included in the traffic when the traffic is monitored using an in-line method in the step (c).

4. The method in accordance with claim 1, wherein the network policy comprises at least one of a network connection time, a network connection software, a connection port, a connected IP address, a user group, a text data included in the packet in the traffic, a file name of a transferred file, a keyword included in the file and a size of the file.

5. The method in accordance with claim 1, further comprising storing a text data included in the packet and a transferred file.

6. The method in accordance with claim 5, wherein the step of storing comprises storing a data included in the packet as a large capacity relational database after carrying out a morpheme analysis and an indexing of the data.

7. The method in accordance with claim 1, wherein the step (c) comprises:
mirroring an outbound traffic transmitted from the first user terminal and an inbound traffic transmitted from a second user terminal receiving the network traffic; and
monitoring the outbound traffic and the inbound traffic.

8. The method in accordance with claim 1, wherein the step (d) comprises analyzing a signature included in the payload.

9. The method in accordance with claim 1, wherein the step (d) comprises analyzing the payload to determine whether the payload includes a personal identification information including a credit card number, an account number and a cellular phone number, a personal information and a confidential company information.

10. The method in accordance with claim 1, further comprising notifying the blocking of the communication to an administrator in a real time.

11. The method in accordance with claim 10, wherein the blocking of the communication is notified to the administrator via at least one of an email, an SMS and the instant messenger software.

12. The method in accordance with claim 1, further comprising decoding a data included in the packet when the data is encoded by at least one of a multi-language analysis, a two byte character processing, a MIME and an UTF.

13. A network traffic control system for controlling a traffic generated by at least one of a P2P software and an instant messenger software, the system comprising a control module for monitoring a communication through one of a P2P software and an instant messenger software and analyzing a header and a payload of a packet included in the traffic based on a network policy assigned to the analysis to notify a blocking of the communication or a generation of a packet to be blocked to a first user.

14. The system in accordance with claim 13, wherein the control module transmits at least one of a session termination signal and a reset signal to a first user terminal and a second user terminal receiving the traffic to terminate a session when the traffic is monitored using a mirroring method.

15. The system in accordance with claim 13, wherein the control module blocks the communication by dropping the packet included in the traffic when the traffic is monitored using an in-line method.

16. The system in accordance with claim 13, wherein the network policy comprises at least one of a network connection time, a network connection software, a connection port, a connected IP address, a user group, a text data included in the packet in the traffic, a file name of a transferred file, a keyword included in the file and a size of the file.

17. The system in accordance with claim 13, further comprising a storage module for storing a text data included in the packet and a transferred file.

18. The system in accordance with claim 17, wherein the storage module comprises a large capacity relational database.
